(19) United States
(12) Patent Application Publication
(10) Pub. No.: US 2004/0118025 A1
(43) Pub. Date: Jun. 24, 2004

(54) Sand art system and method

(76) Inventor: Robyn Shalit, Princeton Junction, NJ (US)

Correspondence Address: LERNER, DAVID, LITTENBERG,, KRUMHOLZ & MENTLIK, 600 SOUTH AVENUE WEST, WESTFIELD, NJ, 07090, US

(21) Appl. No.: 10/323,364

(22) Filed: Dec. 19, 2002

(51) Int. Cl. G09F 1/08

(52) U.S. Cl. 40/538

(57) ABSTRACT

A particulate-filled article and method of creating the article is disclosed. The article includes a flexible container and is filled with at least one type of particulate material. Other materials such as pliable solid materials and sponge-like materials may be arranged within a cavity of the article along with the particulate material. The particulate materials may be various colored sands or other particulate materials. A method of fabricating the article is also disclosed.

### BACKGROUND OF THE INVENTION

This invention relates generally to the use of sand art techniques for fabricating novelty items, amusement devices, craft kits, toys and other artistic and decorative products, items and devices. More particularly, the invention relates to articles and products using shaped and sized flexible resilient containers in which colored sand is placed.

Sand art has become a popular craft enjoyed by both children and adults. It requires placing sand, preferably of various colors, in a translucent container. Thus, flowable small particulate matter, such as colored sand or other particles of material for creating and fashioning visible patterns within an object such as a bottle, a bowl, a lamp base and other translucent objects, are known in the prior art.

It is also known in the prior art to utilize small particulate media or materials such as beads, crystals and beans to fill flexible bags such as bean bags, as lounging spots or for tossing toys, etc.

However, the prior art does not disclose the use of sand art, or a similar craft, for placing particulate material, such as sand of the like, having a plurality of colors within a flexible container made of a translucent material. The prior art also fails to disclose a sand art system, or similar craft, where sand is placed within a flexible translucent container along with other fill materials, such as sponges, clay, pipe cleaners, and the like.

The present invention addresses the shortcomings of the prior art by providing a sand art system and method where a particulate material having multiple colors is placed within a flexible translucent container.

The prior art also does not disclose a sand art system including support materials such as flexible elongate support members (e.g., pipe cleaners or the like), or materials such as clay positioned in a flexible container along with particulate material to maintain the shape of the flexible container. Further, the prior art does not disclose a sand art system including fillers such as sponges or polyurethane foam inserted along with sand within a flexible container.

### SUMMARY OF THE INVENTION

In a preferred embodiment, an article comprising a flexible container defining a cavity is provided. The flexible container includes a translucent material. Particulate material having a plurality of colors is arranged within the cavity of the flexible container whereby the flexible container displays a desired design and has a desired three-dimensional size and shape.

Preferably, the particulate material comprises a first sand having a first color and a second sand having a second color. Other particulate materials, include, but are not limited to, beads and the like. In addition, the particulate material may comprise a combination of materials made of different colors. Other fill materials may be arranged within the flexible container along with the particulate material. Examples of other fill materials include sponge material and pliable material (such as clay, pipe cleaners or any other type of flexible elongated member and the like).

In a preferred embodiment, the cavity of the flexible container may have a first section and one or more additional sections. Preferably, the first section includes a larger volume than any one of the other sections. While the specific shape of the flexible container is not intended to be limited, examples of preferred shapes include that of a hand, various animals, and an infinite variety of other objects and things.

The flexible container may have at least one sealable opening in communication with the cavity. Preferably, an object is arranged within the at least one sealable opening after all desirable fill materials have been arranged within the cavity. Thus, the fill materials would be precluded from being easily removed from the flexible container. The object arranged within the sealable opening may form a base on which the flexible container rests. In a preferred embodiment, the base may comprise a piggy-bank. In other embodiments, the base may comprise a cup. It should be understood that the scope of the present invention is not intended to be limited by the type of object used to seal the flexible container after the particulate material, or any other fill material, is placed therein.

Thus, one aspect of the present invention relates to a shaped and sized flexible resilient container made of a translucent material, in which relatively small or fine particulate colored materials, such as colored sand or beads, are placed.

It is another aspect of the present invention to utilize a flexible plastic container which can be filled by a sand art technique using particulate matter to form a desired three-dimensional object or thing.

It is another aspect of the present invention to provide a method utilizing a sand art technique for creating a filled and formed flexible container having an artistic and decorative design.

Additional objects, advantages and features of the present invention will become apparent from the detailed description which follows below, taken together with the accompanying drawings.

### BRIEF DESCRIPTION OF THE DRAWINGS

FIG. 1 is a perspective view of a preferred embodiment of the present invention illustrating a translucent flexible container in the shape of a hand filled with various colored sand and other materials.

FIG. 2 is a cross-sectional view of the present invention taken along line 2-2 of FIG. 1.

FIG. 3 is a perspective partially cut-away view of a second embodiment of the present invention illustrating a translucent flexible container in the shape of an animal having accessories thereon.

### DETAILED DESCRIPTION

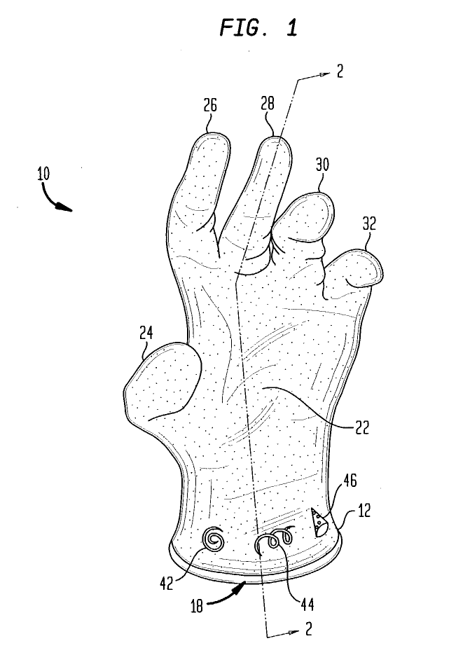

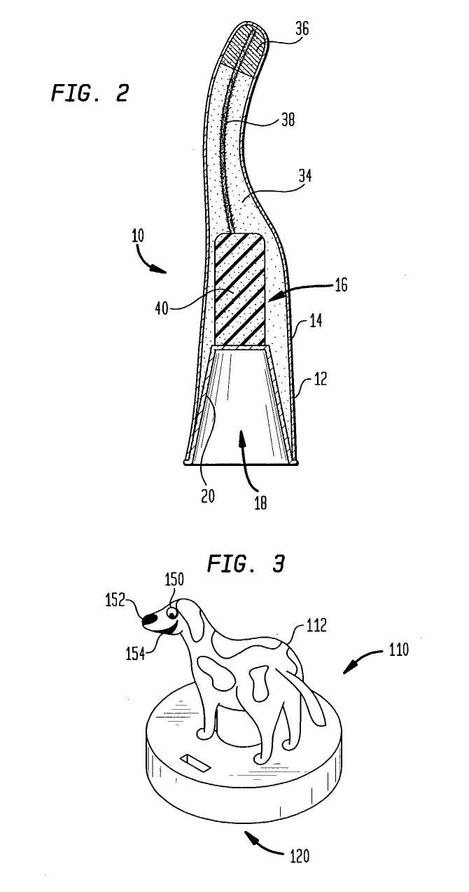

FIGS. 1 and 2 illustrate a preferred embodiment of the invention as an article generally designated 10 comprising a flexible resilient container 12 having a cavity defined by inner wall 14. The flexible container 12 is in the shape of a human hand, in which the cavity 16 defined by inner wall 14 has been filled with materials to give the flexible container 12 the three-dimensional shape as shown. The hand-like shape of the flexible container 12 has only been selected for purposes of illustration. Those skilled in the art will readily recognize that the flexible container 12 can take any desired shape, form or size. For example, the shape of an animal, an automobile, a person, a toy, a building, and an indefinite number of other objects, without departing from the scope, purpose and objects of the present invention.

The flexible container 12 is preferably a translucent material made from polymer, copolymer, block-copolymer, resin, rubber, glass or the like. Vinyl is one of many suitable materials. Such materials are well known, and shaped articles made of these materials, such as vinyl or rubber gloves, are easily purchasable in the commercial marketplace. Alternatively, the flexible translucent container 12 made of these materials can be fabricated into any desired shape, form and size by methods which are also well known to those skilled in the art. In the present invention, the flexible container 12 is made of a translucent material in order to enable any design formed within the cavity 16 to be visible in the finished product. The design may be as simple as a combination of colored sand 34, or may be more complex by forming a recognizable pattern or the like.

The flexible container 12 has at least one opening 18 which communicates with the cavity 16. This provides means for filling the cavity 16 with the various materials for imparting the three-dimensional appearance to the particular shape or forms selected for the flexible container 12. When all of the spaces and areas of cavity 16 are filled, a closure object 20 is inserted into the opening 18 to seal or to prevent the materials within the cavity 16 from escaping.

Filling of the cavity 16 is preferably accomplished by positioning the opening 18 above, or at a higher point, than the remaining portions of the flexible container member 12. The desired materials are then placed through the opening 18 for expanding the flexible container 12 into its three-dimensional form. Thus, in the illustrated hand-shape form of the flexible container 12 shown in FIG. 1, the flexible container 12 may be placed in an inverted position where the opening 18 is readily accessible for facilitating placement of fill materials into cavity 16.

The materials to be placed through the opening 18 may vary depending on the size, shape and other factors selected for the flexible container 12. Preferably, such materials will include particulate materials such as sand 34, beads or the like. The sand 34 or beads are preferably colored as one more aspect of the invention relates to filling of the translucent flexible container 12 with multiple colors of sand 34, beads or the like. Clay 36 will have the effect of providing additional pliability and stability to the finished product 10, as will be described below.

The filling of the colored sands 34 or colored regularly or irregularly shaped beads or crystalline materials may be done in accordance with sand art techniques depending on the desired design. Thus, the fill materials can be selected to provide different colored layers or using different colors in various sections. Accordingly the fill materials will not only provide the desired three-dimensional shape of the flexible container 12 but will also provide a desired design, which will be visible by reasons of the translucent material from which the flexible container 12 is made.

Additionally, clay 36 or other pliable material such as pipe-cleaner 38 like structures may be used to fill the flexible container 12. For example, clay 36 may be placed within the finger sections of the flexible container 12.

Particulate materials, such as colored sand 34 or colored shaped beads or crystals are also used to fill the main cavity chamber (i.e., a palm portion 22 of the hand) and the sub-chambers (i.e., the finger portions 24, 26, 28, 30 and 32 of the hand). The main chamber may be considered a first section of the cavity 16 and the sub-chambers may be considered second sections thereof. The multiple colored sand 34 enables designs to be formed, which will be visible through the translucent three-dimensional form of the shaped flexible container 12.

Where the size of the main or sub-chambers of the cavity 16 permits, fillers such as sponges 40 may be added so that smaller quantities of particulate materials such as colored sands 34 or regularly or irregularly shaped beads or crystals will be used to fill the cavity 16 of the flexible container 12.

By reference to FIGS. 1 and 2, the cavity 16 formed in the hand-shaped flexible container 12 has the palm section 22 and a plurality of elongated finger sections as at 24, 26, 28, 30 and 32, continuous with and in communication with the palm section 22. When the flexible container 12 is in the inverted position so that the opening 18 is accessible, the desired fill materials can be readily placed into the respective finger sections 24, 26, 28, 30 and 32. Thus, as shown in the cross-sectional view of FIG. 2, clay 36 is arranged within one of the finger sections 24, 26, 28, 30 and 32.

Further, as shown in FIGS. 1 and 2, after the finger sections 24, 26, 28, 30 and 32 have been filled to expand the finger portions into their three-dimensional form, the palm section 22 may be partially filled in the center section with a filler member, such as a sponge 40 or a piece of polyurethane foam, and then particulate matter such as colored sand 34 or beads.

As also shown in the cross-sectional view of FIG. 2, the completed article 10 may include an elongated and pliable pipe cleaner 38. In particular, the pipe cleaner 38 may be arranged within the finger sections 24, 26, 28, 30 and 32 along with the various types of colored sand 34 and clay (or other pliable material) 36. The pipe cleaner 38 and clay 36, may add the desired degree of stability or pliability to the completed sand art article 10.

When all of the filling materials are arranged within the cavity 16 including the palm section 22 and the associated finger sections 24, 26, 28, 30 and 32, the closure object 20 is placed into the opening 18 so as to close and seal the opening 18 and prevent the filling materials from escaping out of cavity 16 when the flexible container 12 is placed in the upright position to provide the completed appearance of the hand shape or other selected shape.

The closure object 20 can be so formed that it will act as a base, which supports the associated flexible container 12.

By reference to FIG. 1 showing the three-dimensional form of the hand-shaped flexible container 12, designs as at 42, 44 and 46 are printed, stamped or adhesively attached to the exterior surface of the container 12. Such designs are clearly visible as well as the designs formed within the container 12, which are visible through the translucent material of which the flexible container 12 is formed.

An alternate embodiment of the present invention is shown in FIG. 3. The particulate filled article 110 of FIG. 3 is similar to the article 10 of FIGS. 1 and 2. The only differences are in the shape of the article and the base member. In particular, the article 110 of FIG. 3 is in the shape of a dog. The accessories such as eyes 150, a nose 152, and a mouth 154, have been pasted or printed thereon to complete the face of the dog. This embodiment is intended to provide an example how the flexible container 112 of the present invention can assume the shape of substantially any animal, object, etc.

It should be appreciated in alternate embodiments, that the opening into the flexible container may be arranged at various locations, and may comprise multiple openings. Thus, the opening need not be arranged in the vicinity of base 120.

As also illustrated in FIG. 3, a base member 120 is arranged within what would have otherwise been an opening in the flexible container 112. The base member 120 serves the dual purpose of closure to prevent fill materials within flexible container 112 from escaping from the associated cavity (not shown), and performing a stable base on which the flexible container 112 can rest. The base member 120 of FIG. 3 is shown in the form of a piggy bank.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. An article comprising:
a. a flexible container defining a cavity, said flexible container including a translucent material; and
b. particulate material arranged with said cavity, said particulate material having a plurality of colors such that said flexible container displays a desired design and has a desired three-dimensional size and shape.

2. The article of claim 1 wherein said plurality of particulate material comprises at least a first sand having a first color and a second sand having a second color.

3. The article of claim 1 further comprising sponge material arranged within the cavity of said flexible container, said sponge material being at least partially covered by said particulate materials.

4. The article of claim 1 further comprising a pliable solid material arranged within the cavity of said flexible container, said pliable material being at least partially covered by said granular materials.

5. The article of claim 4 wherein said pliable material comprises a clay-like material.

6. The article of claim 4 wherein said pliable material comprises at least one elongate pipe-cleaner-like structure.

7. The article of claim 1 wherein the cavity of the flexible container has a first section and at least one second section, said first section having a larger volume than said at least one second section.

8. The article of claim 1 comprising a base attached to said flexible container, said base being sized and shaped to support said flexible container and said materials therein when placed on a surface.

9. An article comprising:
a. a generally translucent flexible container having a predetermined size and shape, and defining a cavity, said flexible container member having at least one sealable opening in communication with the cavity; and
b. a plurality of fill materials placed within said cavity such that said flexible member contains a three-dimensional size and shape, one of said fill materials having a first color and at least one of the other fill materials having a second color whereby a multi-color design is visible through said translucent flexible member.

10. The article of claim 9 wherein said flexible container comprises a resilient material.

11. The article of claim 10 wherein said resilient material comprises a natural or synthetic polymer.

12. The article of claim 9 wherein said flexible container has an exterior surface, and a pattern, design or indicia formed on said exterior surface.

13. The article of claim 9 wherein the cavity of said flexible container has a first section and at least one second section, said first section having a larger volume than said at least one second section.

14. The article of claim 9 wherein at least one of said various types of fill materials comprises particulate material and at least another of said various types of fill materials comprises a pliable solid material.

15. The article of claim 13 wherein at least one of said various types of fill materials comprises particulate materials, and at least another of said various types of fill materials comprises a sponge material arranged within said first section of said cavity, and said particulate material is arranged within said first and second sections.

16. The article of claim 15 wherein another of said various types of fill materials comprises a solid pliable material, said particulate material surrounding at least a portion of said pliable material within the cavity.

17. The article of claim 13 wherein said generally transparent flexible member comprises the shape of a hand, said first section comprising a main area within said hand shape and said at least one second section comprising a plurality of finger areas within said hand shape.

18. A method of creating a particulate-filled article, said method comprising:
a. providing a translucent flexible container defining a cavity therein and having a sealable opening in communication with the cavity;
b. placing particulate material having a first color through the sealable opening until the desired amount of the particulate material is arranged within the cavity;
c. placing a particulate material having a second color through the sealable opening whereby the first and second colors are visible within the translucent container; and
d. sealing the opening to prevent the particulate material from flowing out of the container.

19. The method of claim 18 further comprising placing a desired amount of particulate material having a third color through the container opening prior to sealing the opening.

20. The method of claim 18 further comprising sealing the opening by placing an object therein.

21. The method of claim 20 further comprising stretching the opening of said flexible container and placing the object therein having a dimension larger than the dimension of the opening prior to placement of the object therein.

22. The method of claim 21 wherein the object placed within the opening forms a substantially stable base and said particulate-filled article can rest in a stable position on the base.

23. The method of claim 18 further comprising placement of a pliable solid material within the opening, said particulate material covering at least a portion of said pliable material within the cavity of the flexible container.

24. The method of claim 18 further comprising placement of a sponge material within the opening, said particulate material covering at least a portion of said sponge material within the cavity of the flexible container.

25. The method of claim 18 further comprising placement of an elongate pipe-cleaner-like structure within the opening, said particulate material covering at least a portion of said elongate pipe-cleaner-like structure within the cavity of the flexible container.

26. The method of claim 23 further comprising placing sponge material through the opening along with the first and second colored particulate material and the pliable material whereby the first and second colored particulate material covers at least a portion of the pliable material and the sponge material.

27. The method of claim 26 further comprising placing an elongate pipe-cleaner-like structure and at least partially covering the elongate pipe-cleaner-like structure with the particulate material of the first or second colors.
